(19) United States
(12) Patent Application Publication
(10) Pub. No.: US 2007/0177344 A1
(43) Pub. Date: Aug. 2, 2007

(54) Portable personal computer

(76) Inventor: Ben Ming Hsia, Sun Valley, CA (US)

Correspondence Address: Raymond Y. Chan, Suite 128, 108 N. Ynez Avenue, Monterey Park, CA, 91754, US

(21) Appl. No.: 11/512,013

(22) Filed: Aug. 28, 2006

Related U.S. Application Data
(63) Continuation-in-part of application No. 11/480,260, filed on Jun. 29, 2006.
(60) Provisional application No. 60/765,405, filed on Feb. 2, 2006.

(51) Int. Cl. G06F 1/16

(52) U.S. Cl. 361/683; 312/223.2

(57) ABSTRACT

A portable personal computer includes a portable casing including a first panel and a second panel to form a carrying case at a storage position, computer components including a screen panel, a CPU circuitry and a keyboard panel spacedly mounted to the first and second panels, and two cushioning elements mounted on the first and second panels not only to retain the computer components in position but also for absorbing an external impact force to the computer components so as to protect the computer components, wherein at the usage position, the first panel is upwardly folded at an angle with respect to the second panel to form a computer station to support the computer components.

### CROSS-REFERENCE OF RELATED APPLICATION

This is a continuation-in-part application of a non-provisional application, having an application Ser. No. 11/480,260 and a filing date of Jun. 29, 2006, which is a non-provisional application of a provisional application having an application No. 60/765,405 and a filing date of Feb. 2, 2006.

### BACKGROUND OF THE PRESENT INVENTION

1. Field of Invention

The present invention relates to computer, and more particularly to a portable personal computer which comprises a portable casing and a computer components supported therein not only to substantially reduce the overall manufacturing cost of the computer but also to allow the user to carry the computer without any carrying bag.

2. Description of Related Arts

A conventional notebook computer comprises a computer casing having a screen housing pivotally mounted to a main housing, a LCD screen mounted at the screen housing, and a control circuitry including a keyboard panel mounted at the main housing. However, such notebook computer has several drawbacks.

Since the notebook computer is very fragile, the user usually purchase a carrying case to carry the notebook computer. In other words, the carrying case becomes part of necessary components to protect the notebook computer. Even though the size of the notebook computer is compact, the user must carry the notebook computer with the carrying case everywhere. In addition, it is a hassle for the user to place the carrying case in a secure location for preventing the carrying case from being stolen while the notebook computer is being used.

Furthermore, in order to protect the notebook computer, the carrying case must have the cushion layer for absorbing an external impact force against the notebook computer when the notebook computer is received in the carrying case. Therefore, the overall weight of the carrying case will be substantially increased. It is unreasonable that the carrying case is heavier than the notebook computer while the weight of the notebook computer is about 2 lbs.

The cost of the notebook computer is extremely expensive because of the computer casing. The manufacturer must tailor make the screen housing and the main housing to fit the LCD screen and the keyboard panel.

In addition, the distance between the keyboard panel and the LCD screen is limited by the computer casing. Some notebook computers are used as a replacement of a desktop computer. However, the user should keep an optimum comfort distance between the eyes and the LCD screen while the keyboard panel will be far away from the user. Therefore, the user, especially for children, is suggested not to use such notebook computer which may hurt the eyes of the user if the notebook computer is placed closed to the user during the notebook computer is being used.

### SUMMARY OF THE PRESENT INVENTION

A main object of the present invention is to provide a portable personal computer which comprises a portable casing and a computer components supported therein not only to substantially reduce the overall manufacturing cost of the computer but also to allow the user to carry the computer without any carrying bag.

Another object of the present invention is to provide a portable personal computer, wherein a distance between the screen panel and the keyboard panel can be selectively adjusted via the portable casing. Therefore, the portable personal computer of the present invention can be considered as a replacement of the conventional desktop computer.

Another object of the present invention is to provide a portable personal computer, wherein the computer components, such as the screen panel and the keyboard panel, are sealedly mounted to the portable casing to minimize the overall size and weight of the portable personal computer, such that the user is able to easily carry the portable personal computer everywhere.

Another object of the present invention is to provide a portable personal computer, wherein the portable casing is adapted to fold into a storage position to protect the computer components for transportation and to fold into an usage position as a computer stand for the user to operate the computer components such that the portable casing provides multiple tasks to incorporate with the computer components.

Accordingly, in order to accomplish the above objects, the present invention provides a portable personal computer, comprising:

a portable casing comprising a first panel, a second panel, and an edge connector foldably coupling the first panel with the second panel edge-to-edge such that the portable casing is adapted to fold between a storage position and an usage position;

computer components comprising a screen panel sealedly and overlappedly mounted on the first panel, a CPU circuitry sealedly mounted on the second panel to electrically connect to the screen panel, and a keyboard panel sealedly mounted on the second panel to electrically connect to the CPU circuitry, wherein at the storage position, the first panel is spacedly overlapped on the second panel to form a receiving cavity therebetween so as to protect the computer components in the receiving cavity, and at the usage position, the first panel is upwardly folded at an angle with respect to the second panel to form a computer station to support the computer components; and

a support stand movably mounted at the first panel to retain the first panel at the angle so as to support the portable casing at the usage position.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the portable personal computer at the storage position according to a preferred embodiment of the present invention.

FIG. 2 is a perspective view of the portable personal computer at the usage position according to the above preferred embodiment of the present invention, illustrating the support stand retaining the first panel in position.

FIG. 3 is a perspective view of the portable personal computer at the usage position according to the above preferred embodiment of the present invention.

FIG. 4 is a perspective view of a portable personal computer according to a second preferred embodiment of the present invention.

FIG. 5 is an exploded perspective view of the portable personal computer according to the above second preferred embodiment of the present invention.

FIG. 6 is a perspective view of a portable personal computer at the storage position according to the above second preferred embodiment of the present invention.

### DETAILED DESCRIPTION OF THE PREFERRED EMBODIMENT

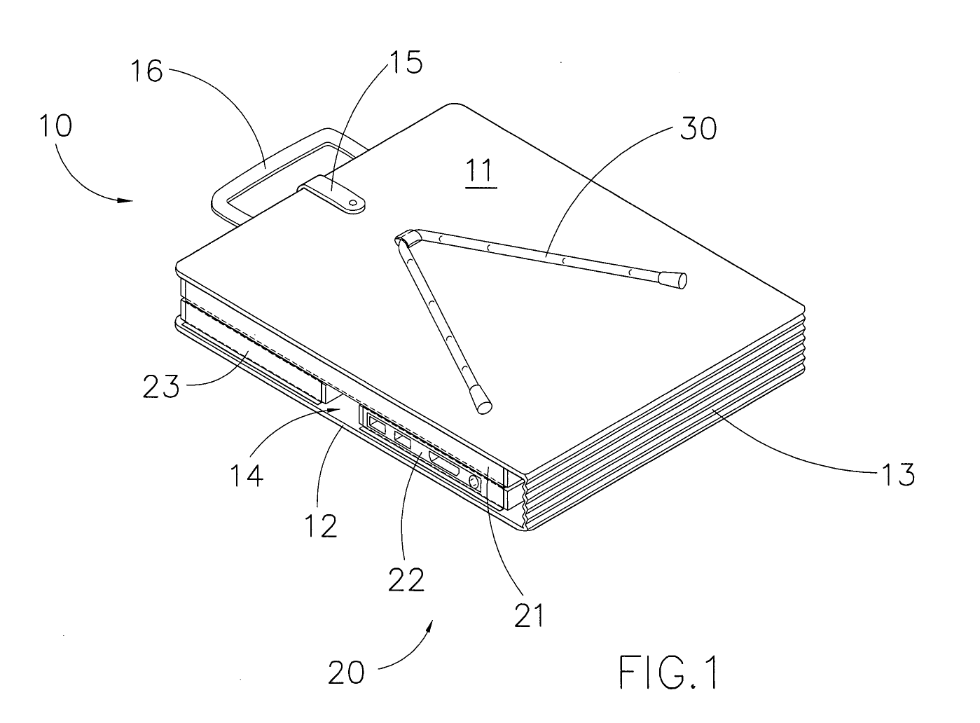

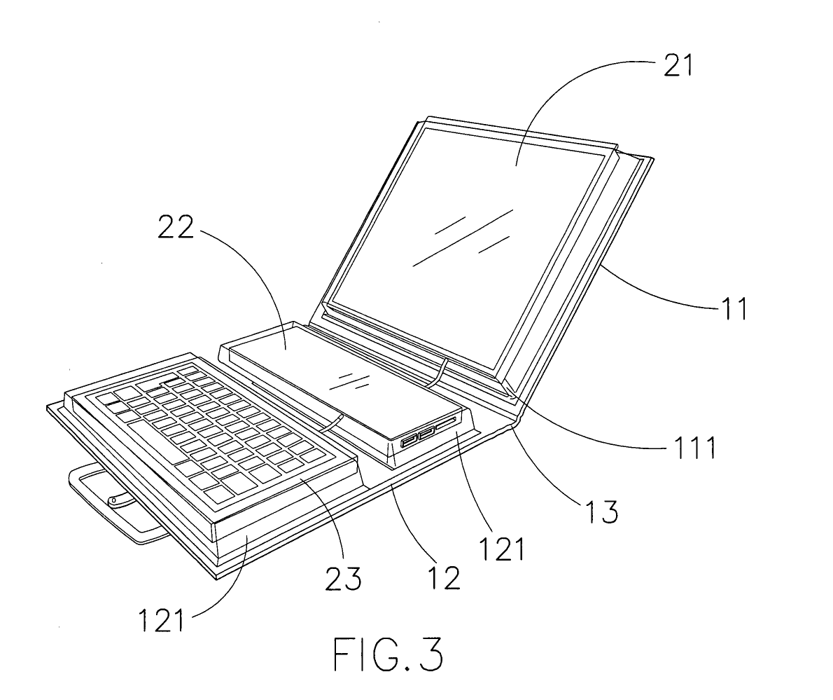

Referring to FIGS. 1 through 3 of the drawings, a portable personal computer according to a preferred embodiment of the present invention is illustrated, wherein the portable personal computer comprises a portable casing 10 and computer components 20.

The portable casing 10 comprises a first panel 11, a second panel 12, and an edge connector 13 foldably coupling the first panel 11 with the second panel 12 edge-to-edge such that the portable casing 10 is adapted to fold between a storage position and a usage position. The portable casing 10 further comprises a lock 15 to lock up the first and second panel 11, 12 at the storage position and a case handle 16 for the user to carry the portable casing 10.

The computer components 20 comprises a screen panel 21 sealedly and overlappedly mounted on the first panel 11, a CPU circuitry 22 sealedly mounted on the second panel 12 to electrically connect to the screen panel 21, and a keyboard panel 23 sealedly mounted on the second panel 12 to electrically connect to the CPU circuitry 22, wherein at the storage position, the first panel 11 is spacedly overlapped on the second panel 12 to form a receiving cavity 14 therebetween so as to protect the computer components 20 in the receiving cavity 14, and at the usage position, the first panel 11 is upwardly folded at an angle with respect to the second panel 12 to form a computer station to support the computer components.

According to the preferred embodiment, the portable casing 10 is made of durable but lightweight material such as plastic or fabric, to minimize the overall weight of the portable personal computer and to protect the computer components 20. The edge connector 13 is integrally extended between the first and second panels 11, 12. In other words, the portable casing 10 can be a sheet of plastic or fabric tri-folding to form the first panel 11, the second panel 12 and the edge connector 13. It is worth to mention that a cushion layer is preferably provided at the first and second panels 11, 12 to absorb the external impact force against the computer components 20 without substantially increasing the weight of the portable casing 10. Accordingly, the portable casing 10 can be made of any material fit for supporting the computer components 20.

According to the preferred embodiment, the computer components 20 are the bare bone components. In other words, the conventional computer components must have outer casing. For example, the conventional LED monitor comprises a screen housing to receive the screen panel and the conventional keyboard comprises a keyboard housing to receive the keyboard panel. However, the present invention omits all the housings of the conventional computer components that only the screen panel 21 and the keyboard panel 23 are used so as to substantially reduce the cost of the present invention. The installation is simple and easy that the user is able to install his or her computer by mounting the computer components 20 at the corresponding positions of the first and second panels 11, 12. It is worth to mention that the portable casing 10 can be replaced such that the user is able to change the portable casing 10 in low cost to keep the aesthetic appearance of the portable personal computer of the present invention.

It is worth to mention that configuration of the computer components 20 is the same as the conventional computer components 20 including all the hardware implementation and software implementation. Accordingly, the computer components 20 further comprises “WiFi” for wireless communication, card reader for reading external data card, and video output for transmitting video signal from the CPU circuitry 22. The portable personal computer of the present invention can be operated by “Linux” or “Windows” as the operation system.

The screen panel 21, which is a LCD screen panel, is sealedly mounted on the inner side of the first panel 11 to retain the screen panel 21 in position. The first panel 11 has a screen-sealing pocket 111 formed on the inner side of the first panel 11 to sealedly receive the screen panel 21 in the screen-sealing pocket 111. Alternatively, the surrounding edge of the screen panel 21 is sealed at the inner side of the first panel 11 to retain the screen panel 21 in position.

Likewise, the keyboard panel 23 is sealedly mounted on the inner side of the second panel 12 and the CPU circuitry 22 is sealed mounted on the inner side of the second panel 12 at the position between the screen panel 21 and the keyboard panel 23. The second panel 12 has two spaced apart sealing pockets 121 to sealedly receive the CPU circuitry 22 and the keyboard panel 23. It can be altered that the two sealing pockets 121 can be combined to form an integral pocket to receive the CPU circuitry 22 and the keyboard panel 23.

The CPU circuitry 22 comprises a CPU unit, computer memory, Ethernet card, and data input device such as card reader or USB port. Accordingly, the user is able to replace/upgrade the computer components 20 by simply wiring the computer components 20. Since the portable casing 10 can be formed in any size and shape, the user can change all the computer components 20 without the limitation of the casing, by simply placing the computer components 20 into the corresponding pockets and wiring them back to the original configuration. Accordingly, the mainboard of the CPU circuitry 22 has a board size approximately 6 inch×4.5 inch.

The distance between the screen panel 21 and the keyboard panel 23 can be selectively adjusted by a width of the edge connector 13. The edge connector 13 can be made of fabric that allows the user to selectively locate the first panel 11 with respect to the second panel 12 via the edge connector 13. It is worth to mention that the first and second panels 11, 12 can be made of plastic and the edge connector 12 can be made of fabric to enhance the practice use of the present invention. For example, the edge connector 13 can be made of fabric having Z-shaped folding structure to allow the user to selectively pull the first panel 11 from the second panel 12 so as to selectively adjust the distance between the screen panel 21 and the keyboard panel 23.

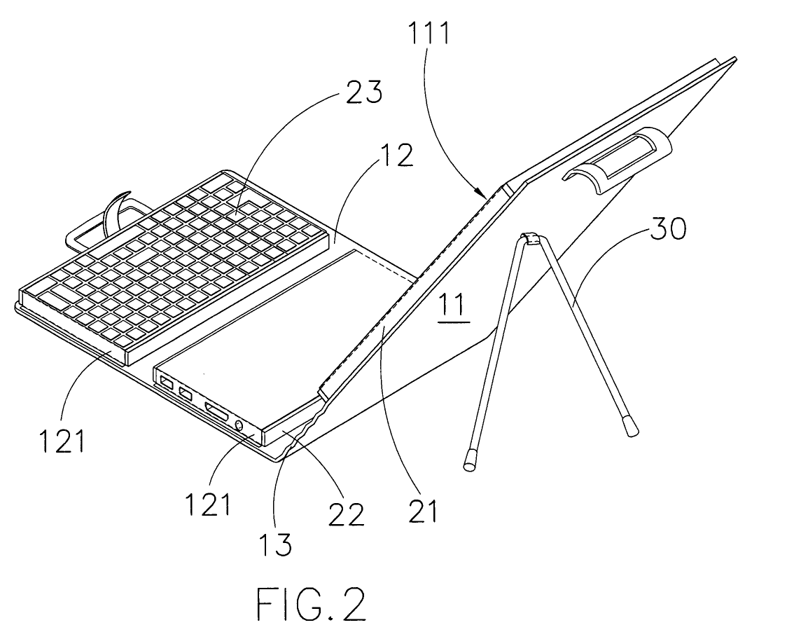

According to the preferred embodiment, the portable personal computer further comprises a support stand 30 movably mounted at the first panel 11 to retain the first panel 11 at the angle so as to support the portable casing 10 at the usage position. As shown in FIG. 2, the support stand 30 has an upper pivot end pivotally connected to the outer side of the first panel 11 and a ground end arranged when the pivot end of the support stand 30 is pivotally folded, the ground end of the support stand 30 stands at the supporting surface to retain the first panel 11 at the usage position.

The user is able to carry the portable personal computer by simply overlapedly folding the first panel 11 on the second panel 12 such that the portable casing 10 forms a carrying case to transport the computer components 20. For usage, the user is able to fold the first panel 11 from the second panel 12 so as to allow the user to access the computer components 20. Therefore, it is a hassle free for the user to place the carrying case in a secure place while using computer. It allows the user to carry the computer without any carrying bag. Due to the flexibility of the edge connector 13, the user is able to selectively adjust the distance between the screen panel 21 and the keyboard panel 23. Therefore, the portable personal computer of the present invention is considered as a replacement of the conventional desktop computer while the user is able to carry the desktop computer everywhere. In other words, the portable personal computer of the present invention provides not only the portability of the conventional notebook computer but also the practice use of the conventional desktop computer.

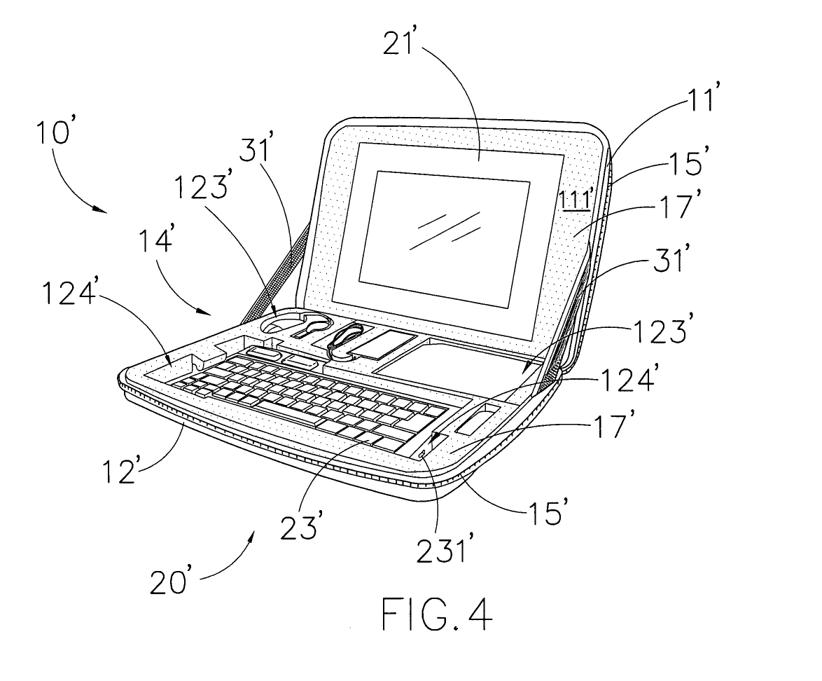

As shown in FIGS. 4 to 6, a second embodiment of the portable personal computer illustrates an alternative mode of the above embodiment of the present invention. The portable personal computer comprises a portable casing 10′ and computer components 20′.

The portable casing 10′, which is a carrying case, is made of durable, waterproof, and lightweight material such as plastic or fabric to formn a soft case so as to minimize the overall weight of the portable personal computer. The portable casing 10′ comprises a first panel 11′ and a second panel 12′ foldably coupling with the first panel 11′ edge-to-edge to fold between a storage position and a usage position. The portable casing 10′ further comprises a lock unit 15′ provided at the first and second panels 11′, 12′ to lock up the first and second panels 11′, 12′ at the storage position and a case handle 16′ extending from the first and second panels 11′, 12′ for the user to carry the portable personal computer at the storage position. Therefore, no additional carrying case is needed to carry the portable personal computer.

The computer components 20′ comprises a screen panel 21′ securely mounted on the first panel 11′, a CPU circuitry 22′ sealedly mounted on the first panel 11′ to electrically connect to the screen panel 21′, and a keyboard panel 23′ securely mounted on the second panel 12′ to electrically connect to the CPU circuitry 22′, wherein at the storage position, the first panel 11′ is spacedly overlapped on the second panel 12′ to form a receiving cavity 14′ therebetween so as to protect the computer components 20′ in the receiving cavity 14′, and at the usage position, the first panel 11′ is upwardly folded at an angle with respect to the second panel 12′ to form a computer station to support the computer components 20′.

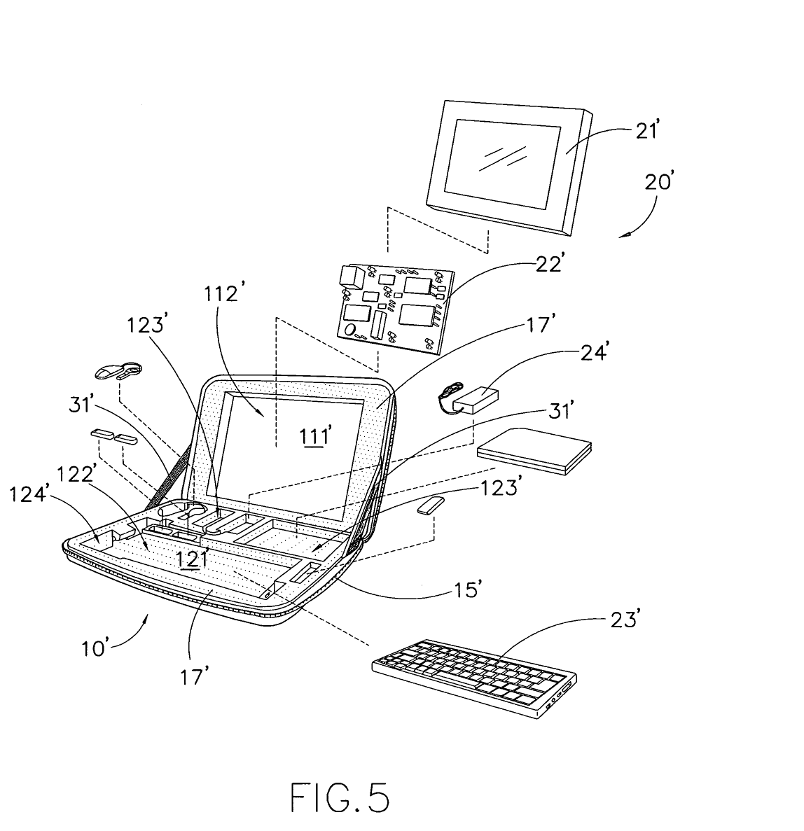

As shown in FIGS. 4 and 5, the first panel 11′ of the portable case 10′ has an inner side 111′ and a first cushioning cavity 112′ indently formed thereon to receive the screen panel 21′ and the CPU circuitry 22′ in the first cushioning cavity 112′. Accordingly, the CPU circuitry 22′ is mounted on the inner side 111′ of the portable case 10′ within the cushioning cavity 112′ at a position behind the screen panel 21′.

The CPU circuitry 22′ comprises a CPU unit, computer memory, Ethernet card, cooling system, and data input device such as card reader or USB port. Accordingly, the user is able to replace/upgrade the computer components 20′ by simply wiring the computer components 20′. Since the portable casing 10′ can be formed in any size and shape, the user can change all the computer components 20′ without the limitation of the casing, by simply placing the computer components 20′ to the corresponding positions and wiring them back to the original configuration.

The second panel 12′ of the portable case 10′ also has an inner side 121′ and a second cushioning cavity 122′ indently formed thereon to receive the keyboard panel 23′ in the second cushioning cavity 122′. It is worth to mention that the keyboard panel 23′ is operatively connected to the CPU circuitry 22′ by pre-wiring the connecting cable between the keyboard panel 23′ and the CPU circuitry 22′ through the inner sides 111′, 121 of the first and second panels 11′, 12′. Alternatively, the keyboard panel 23′ can be wirelessly connected to the CPU circuitry 22′ by any wireless communication device, such as “Bluetooth” or Infrared.

The receiving cavity 14′ is formed between the inner sides 111′, 121′ of the first and second panels 11′, 12′ when the first panel 11′ is foldably overlapped on the second panel 12′ to protect the computer components 20′ between the outer sides of the first and second panels 11′, 12′.

The portable casing 10′ further comprises a holding support 30′ foldably mounted between the first and second panels 11′, 12′ to retain the first panel 11′ at an angle so as to support the portable casing 10′ at the usage position. As shown in FIG. 4, the holding support 30′ comprises at least a side strap 31′ having two ends coupling with the first and second panels 11′, 12′ such that the side strap 31′ retains the angle between the first and second panels 11′, 12′ by the length of the side strap 31′ so as to retain the portable casing 10′ at the usage position.

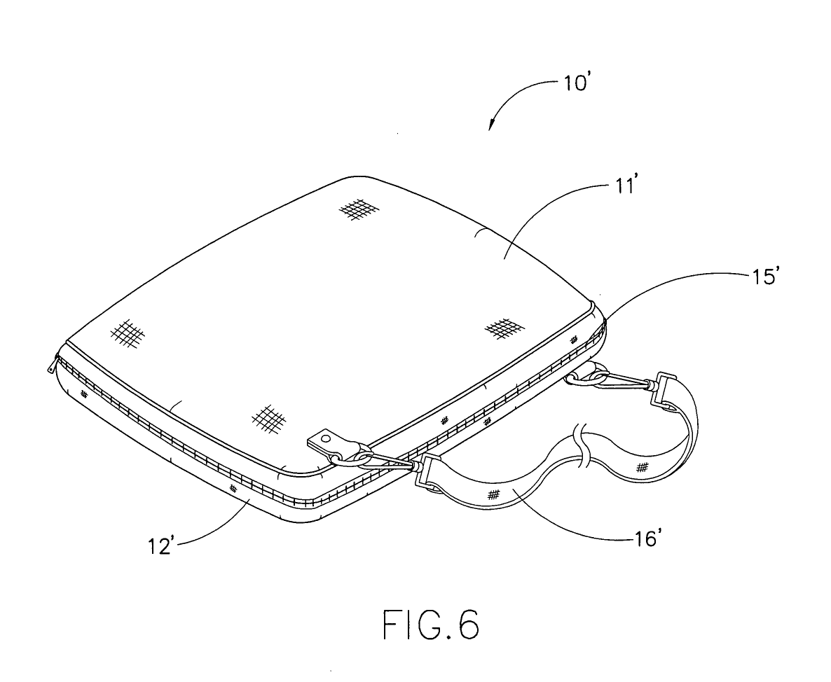

As shown in FIG. 6, the lock 15′ comprises a zipper lock mounted along edges of the first and second panels 11′, 12′ to lock up the first and second panels 11′, 12′ at the storage position.

The portable casing 10′ further comprises two cushioning elements 17′ overlappedly mounted on the inner sides 111′, 121′ of the first and second panels 11′, 12′, wherein the two cushioning elements 17′ are pre-cut to form the first and second cushioning cavities 112′, 122′ to receive the computer components 20′ therein. Accordingly, the cushioning elements 17′ are made of foam material or sponge material to absorb an external impact force so as to protect the computer components 20′ without substantially increasing the weight of the portable casing 10′. It is worth to mention that by using the foam or sponge material, the cushioning elements 17′ not only substantially absorb the impact force against computer components 20′ but also precisely form the first and second cushioning cavities 112′, 122′ to fit the computer components 20′ so as to prevent any unwanted movement of the computer components 20′ within the first and second cushioning cavities 112′, 122′. In addition, the keyboard panel 23′ has a plurality of peripheral accessing ports 231′, such as USB port, for externally connecting with computer accessories. Therefore, at least an accessing cavity 124′ is formed at the corresponding cushioning element 17′ to communicate with the second cushioning cavity 122′ for allowing the user to connect the computer accessories to the peripheral accessing ports 231′ without taking out the keyboard panel 23′ from the second cushioning cavity 122′.

As it is mentioned above, all the computer components 20′ are the bare bone components to substantially reduce the cost of the present invention. In addition, the installation is simple and easy that the user is able to install his or her computer by mounting the computer components 20′ at the corresponding positions of the first and second panels 11′, 12′. It is worth to mention that the portable casing 10′ can be replaced such that the user is able to change the portable casing 10′ in low cost to keep the aesthetic appearance of the portable personal computer of the present invention.

In addition, no hard disk is needed for the portable personal computer of the present invention. In order to minimize the necessary components of the portable personal computer, an alternative storage, such as ROM, is used as a substitution of the conventional hard disk. The portable personal computer of the present invention can be preferably operated by “Linux” or other operation system such as “Windows Mobile 2003 SE” to enhance the efficiency of the portable personal computer. In addition, the alternative storage is expandable in order to allow the user to upgrade the portable personal computer of the present invention.

The CPU circuitry 22′ further comprises a wireless communication module comprising wireless adapter which integrated with “Wi-Fi” and/or “Bluetooth”, so as to allow the user to wirelessly browse the web sites through Internet and to wirelessly link to other compatible accessories, such as mobile phone.

The keyboard panel 23′ is detachably received in the second cushioning cavity 122′ such that the keyboard panel 23′ is adapted to remove from the portable casing 10′ without disconnecting the keyboard panel 23′ with the CPU circuitry 22′. In other words, the distance between the screen panel 21′ and the keyboard panel 23′ can be selectively adjusted that allows the user to selectively locate the first panel 11′ with respect to the keyboard panel 23′. Accordingly, the user is able to use the portable personal computer of the present invention as a laptop by upwardly folding the first panel 11′ from the second panel 12′ while the keyboard panel 23′ is received in the second cushioning cavity 122′. Likewise, the user is able to use the portable personal computer of the present invention as a computer station or desktop station by upwardly folding the first panel 11′ from the second panel 12′ while the keyboard panel 23′ is taken out from the second cushioning cavity 122′. It is worth to mention that the connecting cable should be long enough for the keyboard panel 23′ to keep the connection between the keyboard panel 23′ with the CPU circuitry 22′ when the keyboard panel 23′ is taken out from the second cushioning cavity 122′. By using the wireless communication device, it is a hassle free for the user to take out the keyboard panel 23′ from the second cushioning cavity 122′ to keep the wireless connection therebetween.

As shown in FIG. 5, the second panel 12′ further has a plurality of accessory cavities 123′ spacedly formed on the inner side 122′ of the second panel 12′ for holding computer accessories in position. One of the cushioning elements 17′ is pre-cut to form the accessory cavities 123′ to mount on the inner side 121′ of the second panel 12′. Accordingly, the computer components 20′ further comprises a computer mouse and “USB” storage, such as DVD Rom, or portable USB flash memory, receiving at the accessory cavities 123′ respectively such that the user is able to use the computer mouse and/or “USB” storage by simply taking the computer mouse and/or “USB” storage from the accessory cavities 123′. In other words, the user is able to carry the portable personal computer of the present invention with all necessary components in one portable casing 10′.

As shown in FIG. 5, the portable personal computer further comprises a user-replaceable battery 24′ received in the portable casing 10′, i.e. one of the accessory cavities 123′, to electrically with the computer components 20′, wherein the user-replaceable battery 24′ is rechargeable and is electrically connected to the CPU circuitry 22′ via an electrical cable such that the user is able to replace the user-replaceable battery 24′ with an addition battery or to recharge the user-replaceable battery 24′ for enhance the portability of the portable personal computer. It is worth to mention that the user-replaceable battery 24′ is an option that the user is able to operate the portable personal computer by simply connecting the computer components 20′ with an external power source via a transformer.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable personal computer, comprising:
a portable casing, which is a soft case made of durable, waterproof, and lightweight material, comprising a first panel and a second panel foldably connecting to said first panel edge-to-edge to fold between a storage position and an usage portion, wherein said portable casing forms a carrying case when said portable casing is folded at said storage position;
computer components comprising a screen panel securely mounted on an inner side of said first panel, a CPU circuitry sealedly mounted at said first panel to electrically connect to said screen panel, and a keyboard panel securely mounted on inner side of said second panel to electrically connect to said CPU circuitry, wherein at said storage position, said inner side of said first panel is overlapped on said inner side of said second panel to form a receiving cavity therebetween so as to protect said computer components in said receiving cavity, and at said usage position, said first panel is upwardly folded at an angle with respect to said second panel to form a computer station to support said computer components; and
two cushioning elements respectively mounted on said inner sides of said first and second panels not only to retain said computer components in position but also for absorbing an external impact force to said computer components so as to protect said computer components.

2. The portable personal computer, as recited in claim 1, wherein one of said cushioning elements contains a first cushioning cavity receiving said screen panel at said first panel and another said cushioning element contains a second cushioning cavity detachably receiving said keyboard panel at said second panel.

3. The portable personal computer, as recited in claim 1, wherein said cushioning elements are made of foam materials to protectively retain said computer components in position and to minimize an overall weight of said portable personal computer.

4. The portable personal computer, as recited in claim 2, wherein said cushioning elements are made of foam materials to protectively retain said computer components in position and to minimize an overall weight of said portable personal computer.

5. The portable personal computer, as recited in claim 1, wherein said computer components are bare bone components of computer.

6. The portable personal computer, as recited in claim 2, wherein said computer components are bare bone components of computer.

7. The portable personal computer, as recited in claim 4, wherein said computer components are bare bone components of computer.

8. The portable personal computer, as recited in claim 1, wherein said portable casing further comprises a zipper lock provided at said first and second panels to lock up said first and second panels at said storage position and a case handle extended from said first and second panels for allowing said portable casing to be carried at said storage position.

9. The portable personal computer, as recited in claim 4, wherein said portable casing fuirther comprises a zipper lock provided at said first and second panels to lock up said first and second panels at said storage position and a case handle extended from said first and second panels for allowing said portable casing to be carried at said storage position.

10. The portable personal computer, as recited in claim 7, wherein said portable casing flurther comprises a zipper lock provided at said first and second panels to lock up said first and second panels at said storage position and a case handle extended from said first and second panels for allowing said portable casing to be carried at said storage position.

11. The portable personal computer, as recited in claim 1, wherein at least one of said cushioning elements further contains a plurality of accessory cavities spacedly formed on said inner side of said second panel for holding computer accessories in position.

12. The portable personal computer, as recited in claim 7, wherein at least one of said cushioning elements further contains a plurality of accessory cavities spacedly formed on said inner side of said second panel for holding computer accessories in position.

13. The portable personal computer, as recited in claim 10, wherein at least one of said cushioning elements further contains a plurality of accessory cavities spacedly formed on said inner side of said second panel for holding computer accessories in position.

14. The portable personal computer, as recited in claim 1, wherein said portable casing further comprises at least a side strap having two ends coupling with said first and second panels, wherein said side strap retains an angle between said first and second panels by a length of said side strap so as to retain said portable casing at said usage position.

15. The portable personal computer, as recited in claim 10, wherein said portable casing further comprises at least a side strap having two ends coupling with said first and second panels, wherein said side strap retains an angle between said first and second panels by a length of said side strap so as to retain said portable casing at said usage position.

16. The portable personal computer, as recited in claim 13, wherein said portable casing further comprises at least a side strap having two ends coupling with said first and second panels, wherein said side strap retains an angle between said first and second panels by a length of said side strap so as to retain said portable casing at said usage position.

17. The portable personal computer, as recited in claim 1, wherein said computer components further comprises an alternative storage for omitting a use of conventional hard disk.

18. The portable personal computer, as recited in claim 16, wherein said computer components further comprises an alternative storage for omitting a use of conventional hard disk.

19. The portable personal computer, as recited in claim 1, further comprising a user-replaceable battery received in said portable casing to electrically with said computer components.

20. The portable personal computer, as recited in claim 18, further comprising a user-replaceable battery received in said portable casing to electrically with said computer components.
